(19) United States
(12) Patent Application Publication
(10) Pub. No.: US 2022/0092531 A1
(43) Pub. Date: Mar. 24, 2022

(54) Shipping Logistics Process

(71) Applicant: Kristen Chislak Huguley, Locust Grove, PA (US)

(72) Inventor: Kristen Chislak Huguley, Locust Grove, PA (US)

(21) Appl. No.: 17/121,895

(22) Filed: Dec. 15, 2020

Related U.S. Application Data
(60) Provisional application No. 63/082,067, filed on Sep. 23, 2020.

(51) Int. Cl. G06Q 10/08; H04L 29/06

(52) U.S. Cl. CPC G06Q 10/0833; H04L 63/0861

(57) ABSTRACT

A shipping and delivery logistics system configured to verify a correct shipment and delivery and method of using the same. The shipping and delivery logistics system employs a plurality of user input devices to take a digital image or video of a package at a point of shipping and again at a point of delivery. The digital images or videos are uploaded to a shipping and delivery logistics platform on a shipping tracking server. The shipping and delivery logistics platform compares the images or videos and authenticates a proper delivery of the package. A user may remotely access the shipping tracking server for confirmation of deliveries. A method of confirming a delivery of a package using the shipping and delivery logistics system is also provided.

### CROSS-REFERENCE TO RELATED APPLICATION

The present application claims priority to, and the benefit of, U.S. Provisional Application No. 63/082,067, which was filed on Sep. 23, 2020 and is incorporated herein by reference in its entirety.

### FIELD OF THE INVENTION

The present invention generally relates to supply chain verification process, and more specifically to a shipping and delivery tracking and verification process. Accordingly, the present specification makes specific reference thereto. However, it is to be appreciated that aspects of the present invention are also equally amenable to other like applications, devices and methods of manufacture.

### BACKGROUND

Large and small logistics companies have immense trouble discovering what issues arise at any level of the company during the shipping and delivery process. Additional costs can be incurred, and revenue can be lost if products are constantly lost, damaged, etc. which will lead to decreased company satisfaction. Without some kind of product delivery verification process, companies may be unable to identify which products were safely and securely delivered to a specific location. Delivery mistakes become compounded and costly ultimately leading to a decrease in revenue.

Supply chain management is a multi-faceted process with many stakeholders and even more moving parts. New technologies aim to make the supply chain more efficient yet investing in the wrong technology further complicates productivity while hindering profitability. Traceability, or the ability to track a package or product through shipment and delivery is important in supply chain operations. Lack of traceability and transparency, on the other hand, can create blind spots in a supply chain and expose a company to unnecessary risk. It can weaken consumers' trust in a brand, which can translate into lower sales and profits. It can even give rise to certain legal issues that can stall new product launches.

A combination of consumer expectations, more routes to market, international complexities and other factors creates significant challenges throughout the shipping and delivery network. Common problems include incorrect tracking information on products. Tracking numbers are generated by computer and should be assigned only to their respective orders. But many delivery services prepare and print the shipping labels manually which is susceptible to human error. One of the most common mishaps due to incorrect tracking information is the delivery to the wrong recipient. A mislabeled product will easily be shipped and delivered mistakenly to the wrong place with no further verification process.

In this manner, the improved supply chain verification process of the present invention accomplishes all of the forgoing objectives, thereby providing an easy solution to monitoring and verifying shipping and delivery records for logistics companies. A primary feature of the present invention is the ability to limit access to the process to only verified users. Finally, the improved of the present invention is capable of improving the supply chain shipping and delivery process by catching and resolving shipping and delivery errors as they occur.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a shipping and delivery logistics system. The shipping and delivery logistics system comprises a plurality of user input devices and a shipment tracking server. Each of the user input devices may be a mobile electronic device, such as a camera-equipped smart phone or other internet connected user input device. The user input devices each comprises a non-transitory, computer-readable medium comprising software instructions that, when executed by at least one processor, causes the at least one processor to access the shipment tracking server via a network. The software instructions may be configured as a mobile application. Each user input device requires a user authentication verification to access the shipping and delivery logistics system.

The shipping and delivery logistics system further comprises a shipping and delivery logistics platform for interacting with the plurality of user input devices. The shipment tracking server is configured to receive a first digital file of a package at a point of shipping from one of the user input devices. The shipment tracking server is further configured to receive a second digital file of the package at a point of delivery from one of the user input devices. The shipment tracking server then communicates the first and second digital files to the shipping and delivery logistics platform. The shipping and delivery logistics platform is configured to compare the first and second digital files and authenticate a successful delivery of the package. The shipping and delivery logistics platform is remotely accessible for a user to obtain confirmation of the successful delivery.

The subject matter disclosed and claimed herein, in an additional embodiment thereof, comprises, a method of confirming a shipment and delivery of a package. The method comprises the steps of selecting a digital recording format on a plurality of user input devices. The digital recording format may be a digital picture or a digital video. Each of the user input devices may be a mobile electronic device, such as a camera-equipped smart phone or other internet connected user input device. The user input devices each comprises a non-transitory, computer-readable medium comprising software instructions that, when executed by at least one processor, causes the at least one processor to access a shipment tracking server via a network. Each user input device requires a user authentication verification to access the shipping and delivery logistics system.

Next, a first digital file of a package is recorded at a point of shipping by one of the plurality of user input devices. The first digital file is uploaded to the shipment tracking server and stored on a shipping and delivery platform. Once the package is shipped, a second digital file of a package is recorded at a point of delivery by another of the plurality of user input devices. The second digital file is also uploaded to the shipment tracking server and stored on a shipping and delivery platform. Next, the shipping and delivery platform is used to compare the first and second digital files to confirm a successful delivery of the package. Finally, a user may remotely access the shipping and delivery platform on the shipment tracking server to view a successful package delivery.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of one embodiment of a shipping and delivery logistics system of the present invention configured to verify a correct shipment and delivery in accordance with the disclosed architecture;

FIG. 2 illustrates a perspective view of a user using a camera-equipped input device of the shipping and delivery logistics system of the present invention to take a digital picture of a package in accordance with the disclosed architecture;

FIG. 3 illustrates perspective view of a user using a camera-equipped input device of the shipping and delivery logistics system of the present invention to take a digital picture of a package in accordance with the disclosed architecture;

FIG. 4 illustrates a perspective view of a user tracking a package using the shipping and delivery logistics system of the present invention in accordance with the disclosed architecture;

FIG. 5 illustrates a perspective view of a user tracking a package using the shipping and delivery logistics system of the present invention in accordance with the disclosed architecture; and

FIG. 6 illustrates a flowchart of a method of tracking a package and verifying a successful delivery using the shipping and delivery logistics system of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, is a mobile software application for use in monitoring and verifying shipping and delivery records. Verified users can access the application and ensure that shipments and deliveries are recorded by photograph or video and the results uploaded to a database for review by other authorized users. A user agreement clause and capabilities for remembering a user identification and password information may be stored on the application. The invention ensures that a company's logistics operate smoothly eliminating the worry that packages will be lost, stolen, or otherwise mishandled.

The multipurpose software application is specifically configured to help logistics companies function efficiently. The application allows companies to record all shipments and deliveries with photo and video evidence, offering a way to view each individual transaction to avoid mistakes, theft, and more. The application can be used only by authorized personnel within the company. Data input into the application can be viewed by important people within the company such as managers, CFOs, CEOs, and the like. The application requires a user agreement clause and verification method such as scanning a driver's license, text confirmation, or email confirmation. The authorized user can input a user ID and password that is saved and recorded within the application for convenience. When the application is opened, a dropdown list can be presented to autofill all information for country and language.

When a shipment is delivered or processed, photo and video evidence can be recorded. The process is uploaded to a database and can be shared with appropriate management personnel. Company owners can view all transactions through the application at their leisure. All information can help improve overall logistics within the company and improve customer feedback and experience. The application ensures all shipments and deliveries are completed without mistakes. If a mistake occurs, the mistake can be quickly identified and rectified before negative customer interaction.

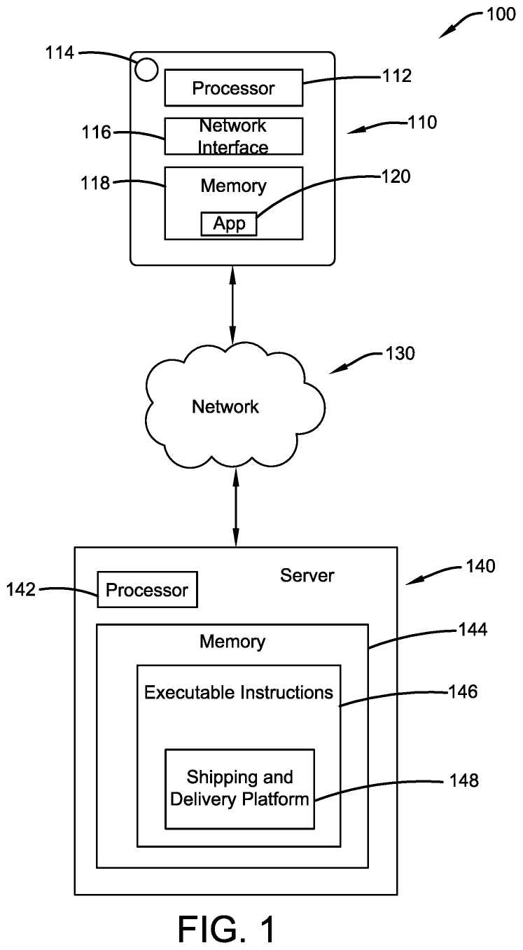

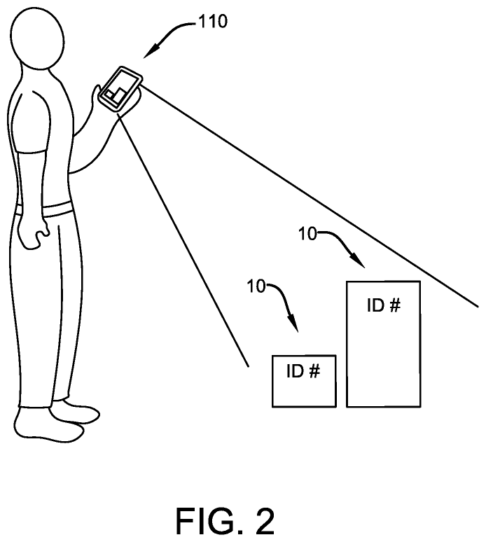

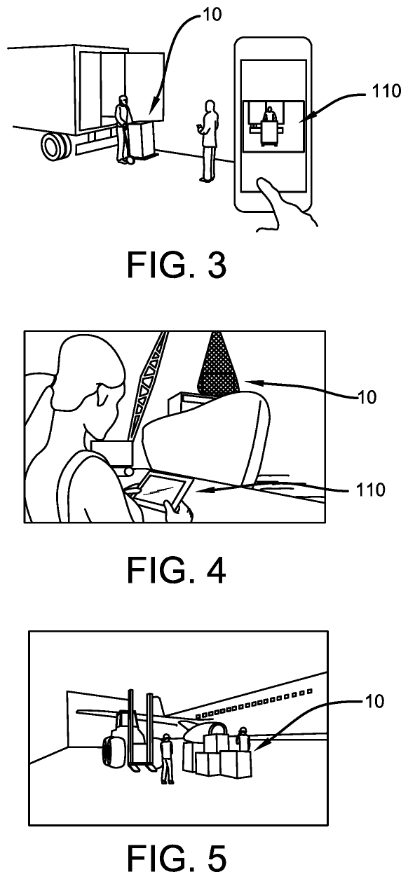

Referring initially to the drawings, FIG. 1 illustrates a schematic representation of a shipping and delivery logistics system 100. The shipping and delivery logistics system 100 is configured to verify a correct shipment and delivery of a package 10 as illustrated in FIGS. 2-5. The package 10 may be anything that is shippable, such as boxes, containers, intermodal containers, packaging, air freight, and the like in any mode of shipping or delivery. The shipping and delivery logistics system 100 comprises a plurality of user input devices 110 and a shipment tracking server 140. Each of the user input devices 110 may be a mobile electronic device, such as a camera-equipped smart phone or other internet connected user input device.

Each user input device 110 is equipped with at least one processor 112, a camera 114, a network interface 116, and a memory. The camera 114 is typically a digital camera and video recorder. The at least one processor 112 may be a processing system of the user input device 110 and is configured to execute instructions that are stored in the memory. Each user input device 110 comprises a non-transitory, computer-readable medium 118 comprising software instructions 120 that, when executed by at least one processor 112, causes the at least one processor 112 to access the shipment tracking server 140 server via a communications network 130 using the network interface 116. The software instructions 120, typically in the form of a mobile application, are stored in the non-transitory, computer-readable medium memory 118 and allow the user input devices 110 to perform methods of the present technology when executed by the at least one processor 112.

The shipment tracking server 140 comprises a server processor 142 and a server memory 144. The shipping and delivery logistics system 100 further comprises a shipping and delivery logistics platform 140 in a set of software instructions 146 stored on the shipment tracking server 140 in the non-transitory, computer-readable medium memory 144. The shipment tracking server 140 is accessible by the user input devices 110 via the communications network 130. The communications network 130 may be any of a number of private or public communications mechanisms such as the Internet, a local intranet, a Personal Area Network, a Local Area Network, a Wide Area Network, a Virtual Private Network, or the like. When one of the user input devices 110 is connected to the shipment tracking server 140 via the network 130, the shipping and delivery logistics platform 140 allows the shipment tracking server 140 to perform methods of the present technology when executed by the server processor 142.

The shipping and delivery logistics platform 148 is configured to electronically communicate with the plurality of user input devices 110. The shipment tracking server 140 is configured to receive a first digital file of a package 10 at a point of shipping from one of the user input devices 110. The shipment tracking server 140 is further configured to receive a second digital file of the package 10 at a point of delivery from one of the user input devices 110. The shipment tracking server 140 then communicates the first and second digital files to the shipping and delivery logistics platform 148. The shipping and delivery logistics platform 148 is configured to compare the first and second digital files and authenticate a successful delivery of the package 10. The shipping and delivery logistics platform 148 is remotely accessible for a user to obtain confirmation of the successful delivery via one of the user input devices 110 or electronically without one of the user input devices 110.

The shipping and delivery logistics platform 148 may comprises a calculator feature. The calculator feature provides analysis viewable as charts and data models to allow the user to access data on revenue, the cost of goods sold, sales, wages, transportation data, warehouse data, and the like. The data can be categorized to fit each user and may be viewable as column charts, line charts, pie charts, and the like. Additionally, the shipping and delivery logistics platform 148 can interact with existing SRM systems to update accounting, payroll, utilities, supply and demand functions, income and expense functions, and the like. Typical interactive senecios for the shipping and delivery logistics platform 148 may comprise volume, pricing data, discounts, rebates, volume, mix, material costs, labor rate, shift size, sales commission data, shipping vehicle type, distance, number of stops, labor rates, volume, capacity, pick type, receipt type, packaging configuration, and the like.

Additionally, the shipping and delivery logistics platform 148 may be customized to the particular shipping type, such as trucks, trains, planes, and boats. The user may select the appropriate shipping type, and the shipping and delivery logistics platform 148 is adaptable to that particular metric. As data is input and collected, the charts and data models will automatically configure to show statistical information adapted for the particular delivery method.

The first and second recording formats may be a digital picture or video taken by the camera 114 of the applicable user input device 110. The server processor 142 then upload the first and second digital files to the shipping and delivery logistics platform 148. The shipping and delivery logistics platform 148 then compares the first and second digital files to authenticate the delivery.

Each user input device 110 may requires a user authentication verification to access the shipping and delivery logistics system 100 or to confirm a delivery status. The user authentication verification may be a scanned or uploaded identification card, a text confirmation, a password, an email confirmation, or combinations of the same. Alternatively, the user authentication verification may be a biometric identifier.

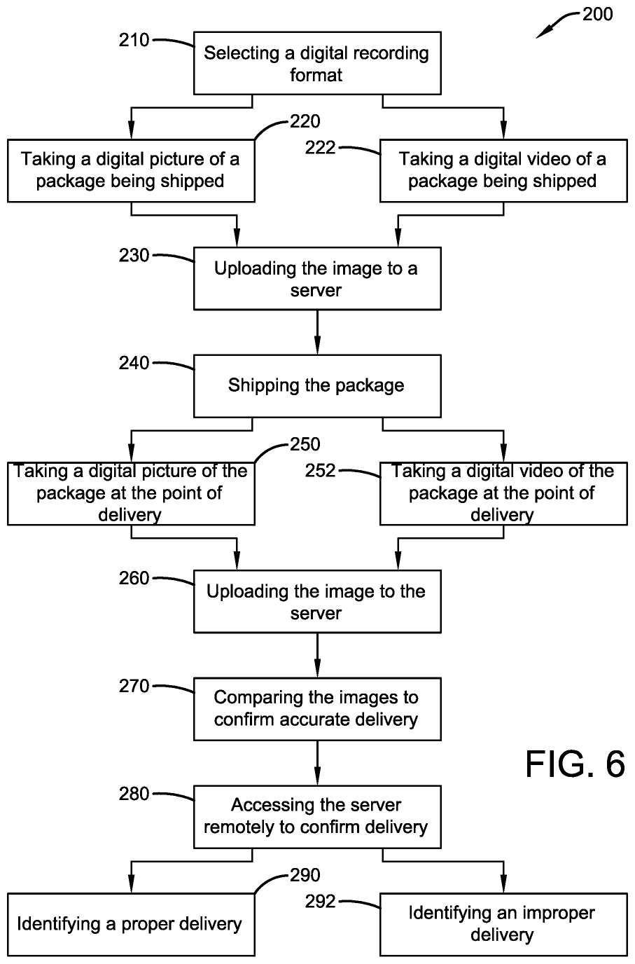

FIG. 6 illustrates a flow chart of an exemplary method 200 of confirming a shipment and delivery or failure of delivery of a package 10 using the shipping and delivery logistics system 100 as described supra. The method 200 comprises the step of selecting a digital recording format on one of a plurality of user input devices 110 at 210. The digital recording format may be a digital picture or a digital video. Then, a first digital file of the package 10 is recorded at a point of shipping by one of the plurality of user input devices 110. At 220, a digital picture of the package 10 being shipped is taken. Alternatively, at 222 a digital video of the package 10 being shipped is taken.

Each of the user input devices 110 may be a mobile electronic device, such as a camera-equipped smart phone or other internet connected user input device. The user input devices 110 each comprises a non-transitory, computer-readable medium 118 comprising software instructions 120 that, when executed by at least one processor 112, causes the at least one processor 112 to access a shipment tracking server 140 via a network 130. Each user input device 110 requires a user authentication verification to access the shipping and delivery logistics system 110. The user authentication verification may be a scanned or uploaded identification card, a text confirmation, a password, an email confirmation, or combinations of the same and may require a two-step authentication process of the user.

At 230, the first digital file is uploaded to the shipment tracking server 140 and stored on a shipping and delivery platform 248 housed in a server memory 144. The package 10 may then be shipped at 240. Once the package 10 is delivered at a delivery destination, a second digital file of the package is recorded at a point of delivery by another of the plurality of user input devices 110. At 250, a digital picture of the delivered package 10 is taken. Alternatively, at 222 a digital video of the delivered package 10 is taken. Next, at 260 the second digital file is also uploaded to the shipment tracking server 140 and stored on a shipping and delivery platform 148. At 270 the shipping and delivery platform 148 is used to compare the first and second digital files to confirm a successful delivery of the package 10. A user may remotely access the shipping and delivery platform 248 on the shipment tracking server 240 electronically via a network 130 at 280 to view a successfully delivered package 10. At 290 the user will identify a properly delivery of the package, or at 292 the user will identify an improper delivery.

It is contemplated that the shipping and delivery logistics system 100 and method of confirming a delivery using the system 200 constructed in accordance with the present invention will be tailored and adjusted by those of ordinary skill in the art to accommodate various levels of performance demand imparted during actual use. Accordingly, while this invention has been described by reference to certain specific embodiments and examples, it will be understood that this invention is capable of further modifications. This application is, therefore, intended to cover any variations, uses or adaptations of the invention following the general principles thereof, and including such departures from the present disclosure as come within known or customary practice in the art to which this invention pertains and fall within the limits of the appended claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A shipping and delivery logistics system configured to verify a correct shipment and delivery comprising:
a plurality of user input devices;
a shipping and delivery logistics platform; and
a shipment tracking server configured to:
receive a first digital file of a package in a first recording format at a point of shipping from one of the user input devices;
receive a second digital file of the package at a point of delivery from another of the user input devices; and
communicate the first and second digital files to the shipping and delivery logistics platform for comparison.

2. The shipping and delivery logistics system of claim 1, wherein the plurality of user input devices each comprise a non-transitory computer-readable medium comprising software instructions that, when executed by at least one processor, causes the processor to access the shipment tracking server.

3. The shipping and delivery logistics system of claim 2, wherein each at least one processor is a processing system of a mobile electronic device.

4. The shipping and delivery logistics system of claim 1, wherein the first recording format is a digital picture.

5. The shipping and delivery logistics system of claim 1, wherein the first recording format is a digital video.

6. The shipping and delivery logistics system of claim 1, wherein each of the plurality of user input devices requires a user authentication verification to access the system.

7. The shipping and delivery logistics system of claim 6, wherein the user authentication verification is one of a scanned identification card, a text confirmation, or an email confirmation.

8. The shipping and delivery logistics system of claim 6, wherein the user authentication verification is a biometric identifier.

9. The shipping and delivery logistics system of claim 1, wherein the shipping and delivery logistics platform is accessible electronically without one of the user input devices.

10. A non-transitory computer-readable medium comprising software instructions that, when executed by at least one processor, causes the processor to:
upload a first digital file of a package in a first recording format at a point of shipping;
upload a second digital file of the package at a point of delivery;
compare the first and second digital files;
authenticate a successful delivery of the package based on the comparison of the first and second digital files.

11. The non-transitory computer-readable medium of claim 10, wherein the first recording format is a digital picture.

12. The non-transitory computer-readable medium of claim 10, wherein the first recording format is a digital video.

13. The non-transitory computer-readable medium of claim 10, wherein the at least one processor is a processing system of a camera-equipped mobile electronic device.

14. The non-transitory computer-readable medium of claim 10, wherein confirmation of a successful delivery requires a user authentication verification.

15. The non-transitory computer-readable medium of claim 14, wherein the user authentication verification is one of a scanned identification card, a text confirmation, a password, or an email confirmation.

16. A method of confirming a shipment and delivery comprising:
selecting a digital recording format;
obtaining a first digital file of a package at a point of shipping;
uploading the digital file to a shipment tracking server;
obtaining a second digital file of the package at a point of delivery;
uploading the second digital file to the shipment tracking server;
using a shipping and delivery logistics platform on the shipment tracking server to compare the first and second digital files to confirm a successful delivery of the package.

17. The method of claim 16, wherein the digital recording format is a digital picture.

18. The method of claim 16, wherein the digital recording format is a digital video.

19. The method of claim 16 further comprising the step of remotely accessing the shipping and delivery logistics platform to view the successful delivery of the package.

20. The method of claim 19, wherein remotely accessing the shipping and delivery logistics platform requires a two-step authentication process.
